(19) United States
(12) Patent Application Publication
(10) Pub. No.: US 2004/0042042 A1
(43) Pub. Date: Mar. 4, 2004

(54) Image data processing for printing by a plurality of image printing apparatuses

(75) Inventor: Takehito Utsunomiya, Yokohama (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/650,712

(22) Filed: Aug. 29, 2003

Related U.S. Application Data
(63) Continuation of application No. 09/353,624, filed on Jul. 15, 1999, now abandoned.

(30) Foreign Application Priority Data
Jul. 21, 1998 (JP) 10-219916

(51) Int. Cl. G06F 3/12; G06F 13/00

(52) U.S. Cl. 358/1.15; 358/1.18

(57) ABSTRACT

An image data processing program, includes generating guidance information which guides an assembly of a set of image data to be distributed to a plurality of printers, sending the guidance information to at least one printer, and distributing the set of image data to said plurality of printers.

### BACKGROUND OF THE INVENTION

1. Field of the Invention

The present invention relates to image data processing for printing by a plurality of image printing apparatuses. Particularly, the present invention relates to printing one print job by dividing it among the plurality of image printing apparatuses.

2. Description of the Related Art

It is known that at least one computer and a plurality of printers are connected to a network. It is proposed to print one print job by dividing it among a plurality of printers in order to reduce the printing time of the print job. In such a method, however, the user must look for the same job sheets from among a plurality of printers and arrange them by referring to the page number printed on each sheet. If the printed sheets don't have page numbers, the user must determine the page order of these printed sheets by referring to the contents of each page. This is extremely hard for the user and takes a long time to arrange the printed sheets.

### SUMMARY OF THE INVENTION

An object of the invention is to provide image data processing in which the user can easily arrange the sheets printed utilizing a plurality of image printing apparatuses.

In order to achieve the objects of the invention, the present invention provides an image data processing method which generates guidance information which guides an assembly of a set of image data to be distributed to a plurality of image printing apparatuses, sends the guidance information to at least one image printing apparatus, and distributes the set of image data to the plurality of image printing apparatuses.

In another aspect of the invention, the present invention provides a recording medium, which can be read by a computer or a CPU, storing code for generating guidance information which guides an assembly of a set of image data to be distributed to a plurality of image printing apparatuses, code for sending the guidance information to at least one image printing apparatus, and code for distributing the set of image data to the plurality of image printing apparatuses.

Other objects and features of the invention will be apparent from the following description and the drawings.

### BRIEF DESCRIPTION OF THE DRAWINGS

FIG. 1 shows a constitution of a printing system.

FIG. 2 shows a flow chart of a divided printing process.

FIG. 3 shows an example of a banner sheet and data sheet discharged from a printer.

FIG. 4 shows sheets printed by a plurality of printers in a first embodiment.

FIG. 5 shows sheets printed by a plurality of printers in a second embodiment.

### DETAILED DESCRIPTION OF THE PREFERRED EMBODIMENT

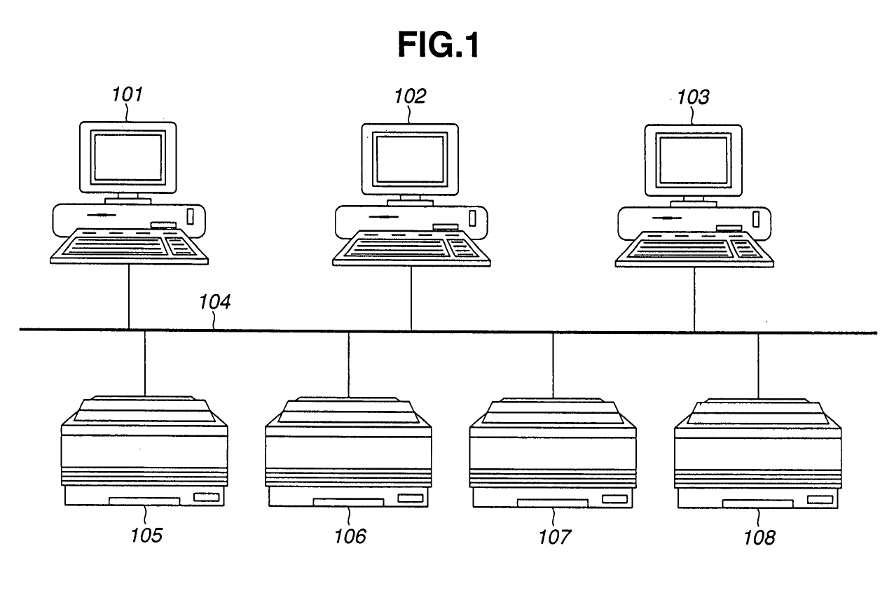

FIG. 1 shows a constitution of a printing system. The system consists of three personal computers 101, 102 and 103, four printers 105, 106, 107 and 108, and network 104. These personal computers and printers are connected to each other through network 104.

Printing data are sent from one of the personal computers to a printer designated by the user. One personal computer can also divide a set of printing data (one print job) into plural parts, and send the parts to a plurality of printers, with each part being sent to a different printer. The printing data are converted to image data which can be printed out at the printer. The printer forms an image on a sheet in accordance with the image data.

Printers 105 through 108 have at least two sheet feeding sections (not shown) each and are able to hold different size sheets or sheets in different orientations at the same time.

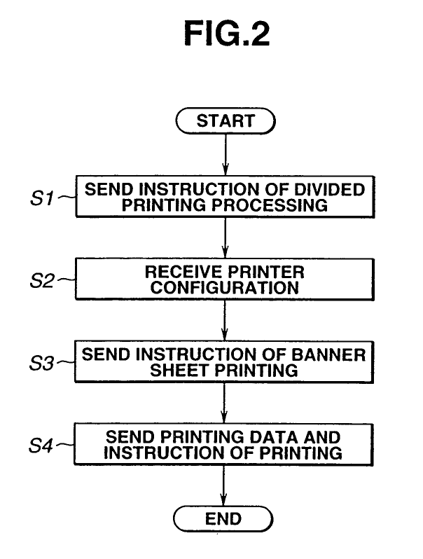

FIG. 2 shows a flow chart of a divided printing process executed in the system shown in FIG. 1. The divided printing process is a process in which a personal computer distributes divided portions of a print job among a plurality of printers and has these printers print the divided data. A program for executing this flow chart is stored in a ROM included in personal computers 101 through 103 in advance, and executed by a CPU included in personal computers 101 through 103. The program is constituted by codes. Instead of storing the program in the ROM, the program could be stored on a hard disc, which is installed inside or outside of personal computers 101 through 103, or on a floppy disc. When the program is needed to execute, the program is loaded to a RAM included in personal computers 101 through 103 from the ROM, hard disc or floppy disc, and executed by the CPU. Alternative mediums for storing this program are not limited to a hard disc and a floppy disc, it could be a CD-ROM, an IC memory card and so on.

In the following embodiment, printing data consisting of 12 pages are printed by printers 105 through 108. The printing data is divided into four groups and distributed to printers 105 through 108. Printer 105 prints the printing data of the first page through the third page. Printer 106 prints the printing data of the fourth page through the sixth page. Printer 107 prints the printing data of the seventh page through the ninth page. Printer 108 prints the printing data of the tenth page through the twelfth page. The printing data is for A4 size sheets.

When an instruction of divided printing is input from the keyboard of personal computer 101, the processing of the above mentioned program is started on personal computer 101. In step S1, personal computer 101 sends the instruction of divided printing processing to each printer to be used. Printers 105 through 108 send a printer configuration in response to the instruction of divided printing processing. In step S2, personal computer 101 receives the printer configuration of each printer to be used.

The printer configuration includes information of whether the printer is a face-up discharge type or a face-down discharge type, information of the sheet sizes held in the printer, and information of the sheet orientations held in the printer. In this embodiment, printers 105 through 108 are face-up discharge type, and hold A4 size sheets and A4R size sheets. The orientations of an A4 size sheet and an A4R size sheet cross at a right angle to each other.

After personal computer 101 receives the printer configuration, personal computer 101 selects a sheet as a banner sheet based on the printer configuration. Since the printing data is to be printed on A4 size sheets, personal computer 101 selects an A4R size sheet as a banner sheet based on the printer configuration. Personal computer 101 sends a banner sheet printing instruction for printing guidance information on the A4R size sheet to each printer 105 through 108 at step S3. For this embodiment, the guidance information consists of a predetermined number printed at a predetermined position on the banner sheet.

In this embodiment, since each printer has A4 size sheets and A4R size sheets, personal computer 101 selects the A4 size sheet as the data sheet for printing the page data and the A4R size sheet as the banner sheet. If each printer has B5 size sheets, B4 size sheets, and A4 size sheets, personal computer 101 would select the A4 size sheet as the data sheet and the B4 size sheet, which is larger than the A4 size sheet, as the banner sheet.

If some printers have A4 size sheets and A4R size sheets and other printers have A4 size sheets and B4 size sheets, personal computer 101 would select the A4 size sheet as the data sheet, and the A4R and the B4 size sheets as the banner sheets.

In this embodiment, personal computer 101 selects printers 105 through 108 before receiving the printer configuration from each printer. As another embodiment, personal computer 101 would request the printer configuration from all printers in the system, receive the printer configuration from each printer and select the printers based on the received printer configuration. Personal computer 101 would select the printers which hold both a data sheet corresponding to the size of the printing data and a banner sheet different from the orientation of the data sheet or larger than the size of the data sheet. For example, personal computer 101 selects the printers which hold A4 size sheets and at least one of A4R size sheets, B4 size sheets, and A3 size sheets.

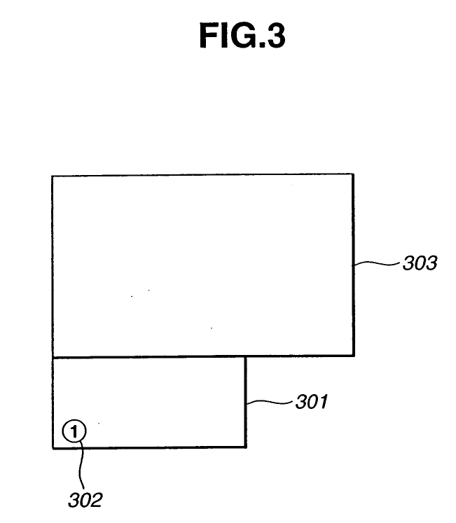

FIG. 3 shows an example of a banner sheet and a data sheet discharged from printer 105. A numeral 301 indicates an A4R size sheet discharged as the banner sheet, and a numeral 303 indicates an A4 size sheet discharged, at a step which is mentioned later, as a data sheet. A circled 1 is printed at the lower left corner of the printing face on sheet 301 in order to help the user who arranges the data sheets printed by a plurality of printers. The number on the banner sheet is printed at a position on the sheet where the number can be seen without moving the banner sheet away from the data sheets. The number printed on the banner sheet shows an order for arranging the data sheets.

Sequential numbers are assigned to each printer to be used. In this embodiment, the number 1 is assigned to printer 105, the number 2 is assigned to printer 106, the number 3 is assigned to printer 107, and the number 4 is assigned to printer 108. The assigned number is sent with the banner sheet printing instruction from personal computer 101 to each printer 105 through 108. At step S4, printing data to be printed by each printer are sent to each printer 105 through 108, followed by the instruction to start printing.

In this embodiment, the printing data consists of 12 pages, therefore 3 pages of data are sent to each printer 105 through 108. More specifically, the data of the first page through the third page are sent to printer 105, to which the number 1 is assigned. The data of the fourth page through the sixth page are sent to printer 106, to which the number 2 is assigned. The data of the seventh page through the ninth page are sent to printer 107, to which the number 3 is assigned. The data of the tenth page through the twelfth page are sent to printer 108, to which the number 4 is assigned.

When each printer receives the printing instruction at step S4, each printer prints an image on an A4 sheet (the data sheet) in accordance with the printing data.

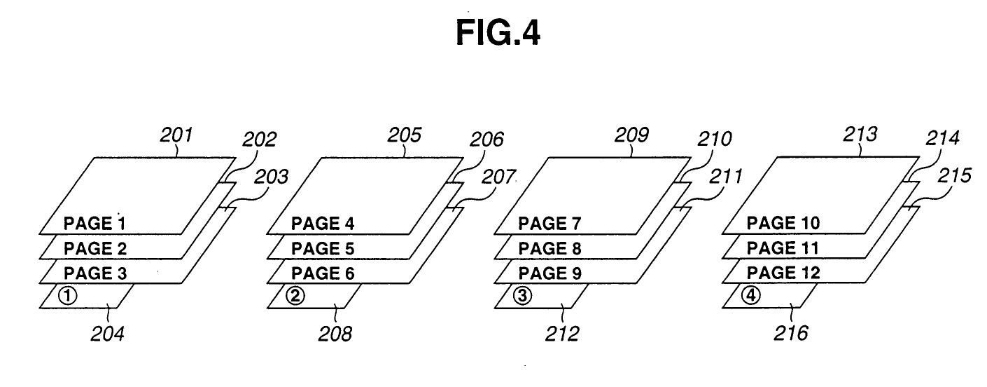

FIG. 4 shows the banner sheets and the data sheets which are printed and discharged from printers 105 through 108 after each printer receives the printing instruction.

Sheets 201 through 204 are printed and discharged by printer 105. Sheet 204 is the banner sheet. Sheets 201 through 203 are the data sheets containing the first page data through the third page data. The orientation of sheet 204 is different from the orientation of sheets 201 through 203. The number 1 is printed on sheet 204 at a position on the sheet where the number can be seen without moving sheet 204.

Furthermore, sheets 205 through 208 are printed and discharged by printer 106, sheets 209 through 212 are printed and discharged by printer 107, sheets 213 through 216 are printed and discharged by printer 108. Sheets 205 through 207 are the data sheets containing the fourth page data through the sixth page data. Sheets 209 through 211 are the data sheets containing the seventh page data through the ninth page data. Sheets 213 through 215 are the data sheets containing the tenth page data through the twelfth page data. Banner sheets, printed with the number assigned to each printer, are stacked under each stack of data sheets in the same manner as the banner sheet stacked at printer 105. The number 2 is printed on sheet 208. The number 3 is printed on sheet 212. The number 4 is printed on sheet 216. The orientation of the sheets 208, 212 and 216 is different from that of data sheets 205 through 207, 209 through 211 and 213 through 215. The numbers on sheets 208, 212 and 216 are printed at a position on the sheets where the number can be seen without moving these sheets.

As a result of executing the above mentioned process, each banner sheet is stacked under each stack of data sheets. The number corresponding to the pages assigned to each printer is printed on the banner sheet. The user can easily stack the sheets printed by a plurality of printers in page order by stacking in accordance with the numbers printed on the banner sheets. The user can easily remove the banner sheets from the stack of sheets because the orientation or size of the banner sheets is different from that of the data sheets. Therefore, the user can easily arrange the sheets printed by a plurality of printers in the correct page order.

In the above embodiment, although all the printers are the face-up discharge type, a part of the printers or all of the printers could be the face-down discharge type. When a part of the printers are the face-up discharge type and the rest of the printers are the face-down discharge type, the sending order of the page data and the placement of the banner sheet are controlled in accordance with the discharge type. Personal computer 101 orders the page data to be sent to the face-up discharge type in descending order and orders the page data to be sent to the face-down discharge type in ascending order. Personal computer 101 sends the instruction of banner sheet before sending the page data to the face-up discharge type printers, sends the instruction of banner sheet after sending the page data to the face-down type printers. Therefore, regardless of whether the selected printer is face-up discharge type or face-down discharge type, the relative position of the data sheet and the banner sheet is fixed. Therefore, the user can assemble the sheets easily without making a mistake.

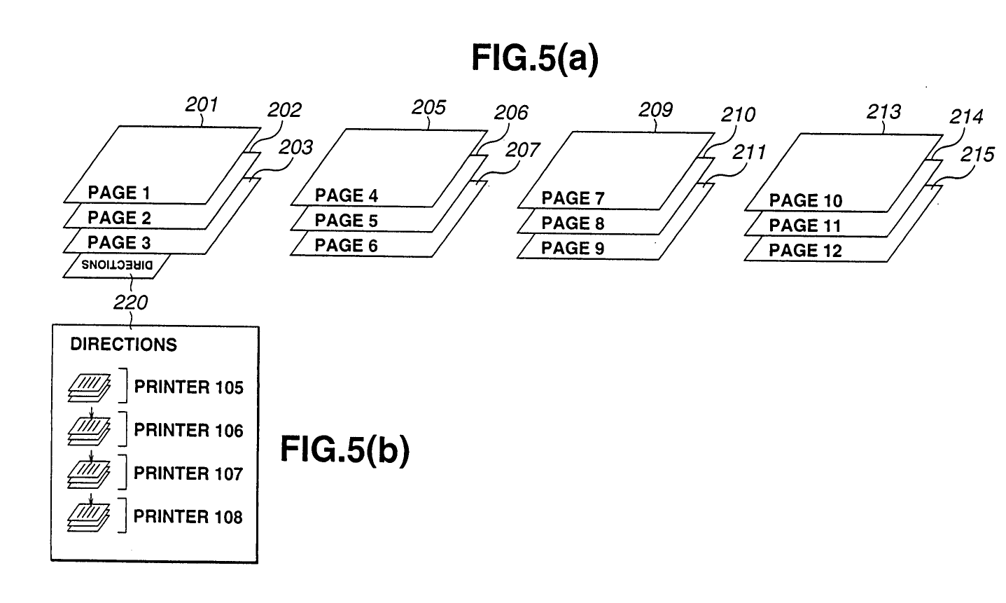

In the first embodiment, although personal computer 101 instructs each printer to print a banner sheet, personal computer 101 could instruct only printer 105 to print the banner sheet 220 as shown in FIG. 5(a), and printers 106 through 108 would not print a banner sheet. In this embodiment, personal computer 101 generates guidance information, or banner data, as shown in FIG. 5(b). The guidance information or banner data provides directions for assembling and arranging the data sheets printed by printers 105 through 108 in order to guide the assembly of the divided print data. Specifically, banner sheet 220 shows which data sheets the user should take and how the user should stack the data sheets.

In the above embodiment, although banner sheet 220 is printed by printer 105, which also prints data sheets 201 through 203, personal computer 101 could instruct printers 105 through 108 not to print a banner sheet and instruct another printer (not shown) to print banner sheet 220.

It is to be understood that the invention is not limited in its application to the details of the description and drawings. Also it is to be understood that the phraseology or terminology employed herein is for the purpose of description and not of limitation.

What is claimed is:

1. An image data processing method, comprising:
generating guidance information which guides an assembly of a set of image data to be distributed to a plurality of image printing apparatuses;
sending the guidance information to at least one image printing apparatus;
distributing the set of image data to said plurality of image printing apparatuses.

2. A method according to claim 1, wherein the guidance information consists of a number indicating an order of arrangement for the set of image data, and
said sending step sends the guidance information to said plurality of image printing apparatuses.

3. A method according to claim 2, wherein the number is one of a sequence of numbers with each number in the sequence assigned to an image printing apparatus to be used.

4. A method according to claim 1, wherein the guidance information consists of directions for assembling and arranging sheets printed by the plurality of image printing apparatuses, and said sending step sends the guidance information to one of said plurality of image printing apparatuses.

5. A method according to claim 1, wherein the guidance information consists of directions for assembling and arranging sheets printed by the plurality of image printing apparatuses, and
said sending step sends the guidance information to an image printing apparatus other than said plurality of image printing apparatuses.

6. A method according to claim 1, further comprising:
indicating an orientation of a sheet to be used to print the guidance information to said image printing apparatus to be used to print the guidance information.

7. A method according to claim 6, further comprising:
receiving orientation information of sheets held by each said image printing apparatus,
wherein said indicating step indicates in accordance with the received orientation information.

8. A method according to claim 1, further comprising:
indicating a size of a sheet to be used to print the guidance information to said image printing apparatus to be used to print the guidance information.

9. A method according to claim 8, further comprising:
receiving size information of sheets held by each said image printing apparatus,
wherein said indicating step indicates in accordance with the received size information.

10. A method according to claim 1, further comprising:
receiving size information or orientation information of sheets held by each said image printing apparatus, and
selecting image printing apparatuses from among a plurality of image printing apparatuses in accordance with the received size or orientation information.

11. A method according to claim 10, wherein said receiving step receives both size and orientation information, and said selecting step selects in accordance with the received size and orientation information.

12. A method according to claim 10, wherein said selecting step selects image printing apparatuses which hold a sheet corresponding to the size required by the set of image data and a sheet different from the orientation of said sheet or larger than the size of said sheet.

13. A recording medium, which can be read by a computer or a CPU, comprising:
code for generating guidance information which guides an assembly of a set of image data to be distributed to a plurality of image printing apparatuses;
code for sending the guidance information to at least one image printing apparatus;
code for distributing the set of image data to said plurality of image printing apparatuses.

14. A recording medium according to claim 13, wherein the guidance information consists of a number indicating an order of arrangement for the set of image data, and
said sending code causes said computer or said CPU to send the guidance information to said plurality of image printing apparatuses.

15. A method according to claim 14, wherein the number is one of a sequence of numbers with each number in the sequence assigned to an image printing apparatus to be used.

16. A recording medium according to claim 13, wherein the guidance information consists of directions for assembling and arranging sheets printed by the plurality of image printing apparatuses, and
said sending code causes said computer or said CPU to send the guidance information to one of said plurality of image printing apparatuses.

17. A recording medium according to claim 13, wherein the guidance information consists of directions for assembling and arranging sheets printed by the plurality of image printing apparatuses, and
said sending code causes said computer or said CPU to send the guidance information to an image printing apparatus other than said plurality of image printing apparatuses.

18. A recording medium according to claim 13, further comprising:
code for indicating an orientation of a sheet to be used to print the guidance information to said image printing apparatus to be used to print the guidance information.

19. A recording medium according to claim 18, further comprising:
code for receiving orientation information of sheets held by each said image printing apparatus,
wherein said indicating code causes said computer or said CPU to indicate in accordance with the received orientation information.

20. A recording medium according to claim 18, further comprising:
code for indicating a size of a sheet to be used to print the guidance information to said image printing apparatus to be used to print the guidance information.

21. A method according to claim 20, further comprising:
code for receiving size information of sheets held by each said image printing apparatus,
wherein said indicating code causes said computer or said CPU to indicate in accordance with the received size information.

22. A recording medium according to claim 13, further comprising:
code for receiving size information or orientation information of sheets held by each said image printing apparatus, and
code for selecting image printing apparatuses from among a plurality of image printing apparatuses in accordance with the received size or orientation information.

23. A method according to claim 22, wherein said receiving code causes said computer or
said CPU to receive both size and orientation information, and
said selecting code causes said computer or said CPU to select in accordance with the size and orientation information.

24. A method according to claim 22, wherein said selecting code causes said computer or said CPU to select image printing apparatuses which hold a sheet corresponding to the size required by the set of image data and a sheet different from the orientation of said sheet or larger than the size of said sheet.
